(19) United States
(12) Patent Application Publication
(10) Pub. No.: US 2005/0204529 A1
(43) Pub. Date: Sep. 22, 2005

(54) Brass bushing press

(76) Inventor: William Scott Richardson, Running Springs, CA (US)

Correspondence Address: William S. Richardson, PO Box 2674, Running Springs, CA, 92382, US

(21) Appl. No.: 10/801,147

(22) Filed: Mar. 16, 2004

(51) Int. Cl. B25B 27/14

(52) U.S. Cl. 29/268

(57) ABSTRACT

A hand tool that presses brass bushings into door hinges of some Chevrolet/GMC trucks. A C-clamp has a modified foot to allow brass bushings to set in a hollowed-out region. The user will easily be able to set the bushings without the aid of another tool.

### BACKGROUND

1. Field of Invention

This invention relates to a hand tool that presses brass bushings into door hinges of some Chevrolet/GMC trucks.

2. Description of Prior Art

Setting brass bushings into place in many truck hinges has been a source of frustration for auto body mechanics, such as me. It is difficult and awkward to hold the bushing straight enough to set it into the door hinge. The standard method of using pliers and/or a hammer to set it runs the risk of damaging the bushing, as brass is a very soft material. Additionally, damage to the vehicle can occur if the hammer slips. If the bushing were to accidentally drop into the fender, it could literally take hours to retrieve and replacements may or may not be readily available.

A recent U.S. Pat. No. 6,128,813 to Rodriquez (2000), attempted to solve the dilemma, but fell short. It still requires the use of a hammer, thus perpetuating the hazard of the hammer slipping or the bushing becoming damaged. Consequently, this invention suffers from a number of disadvantages:
(a) The handle section must be lined up perfectly with the bushing so that it will not be set crooked when hammering.
(b) The hammer must hit the handle section straight on to avoid damaging the shoulder of the bushing itself
(c) The hammer could slip and cause damage to the rocker or fender of the vehicle.
(d) The bushing could still fall into the fender while attempts are made to hammer it into place and time would be lost either retrieving it or ordering a new bushing kit.
(e) The tool user must use both hands to carry out the procedure of installing the bushing.

### SUMMARY

It is prudent to develop a tool that requires no pliers or hammer when setting brass bushings into door hinges of certain model Chevrolet/GMC trucks. The present invention presses the bushings into place without the use of other tools.

Objects and Advantages

The objects and advantages to the present invention are:
(a) to provide a hand tool that does not require the use of both hands.
(b) to provide a single hand tool that can press a brass bushing into place on a door hinge.
(c) to provide a single hand tool that can be used to set both top and bottom bushings by simply turning the hand tool upside down.
(d) to provide a hand tool that can be modified easily from prior art.
(e) to provide a hand tool that auto body mechanics are already familiar with to facilitate use of the present invention.

### PHOTOGRAPHIC FIGURES

FIG. 1 shows an 11SP Vise Grip hand tool before it was modified to the present invention.

FIG. 2 shows the preferred embodiment of the present invention.

FIG. 3 shows a close up of the preferred embodiment of the present invention.

FIG. 4 shows the preferred embodiment about to press a bushing into place in a door hinge.

FIG. 5 shows the preferred embodiment after a bushing has been pressed into place.

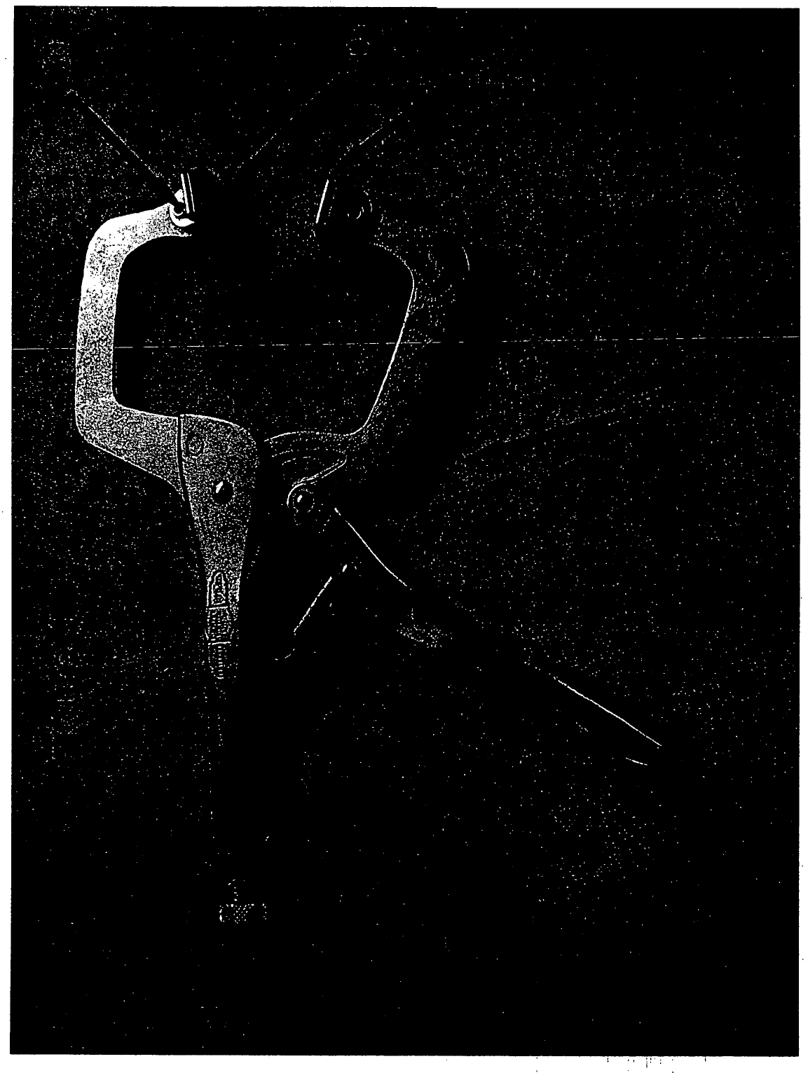

DESCRIPTION—FIGS. 1, 2, 3

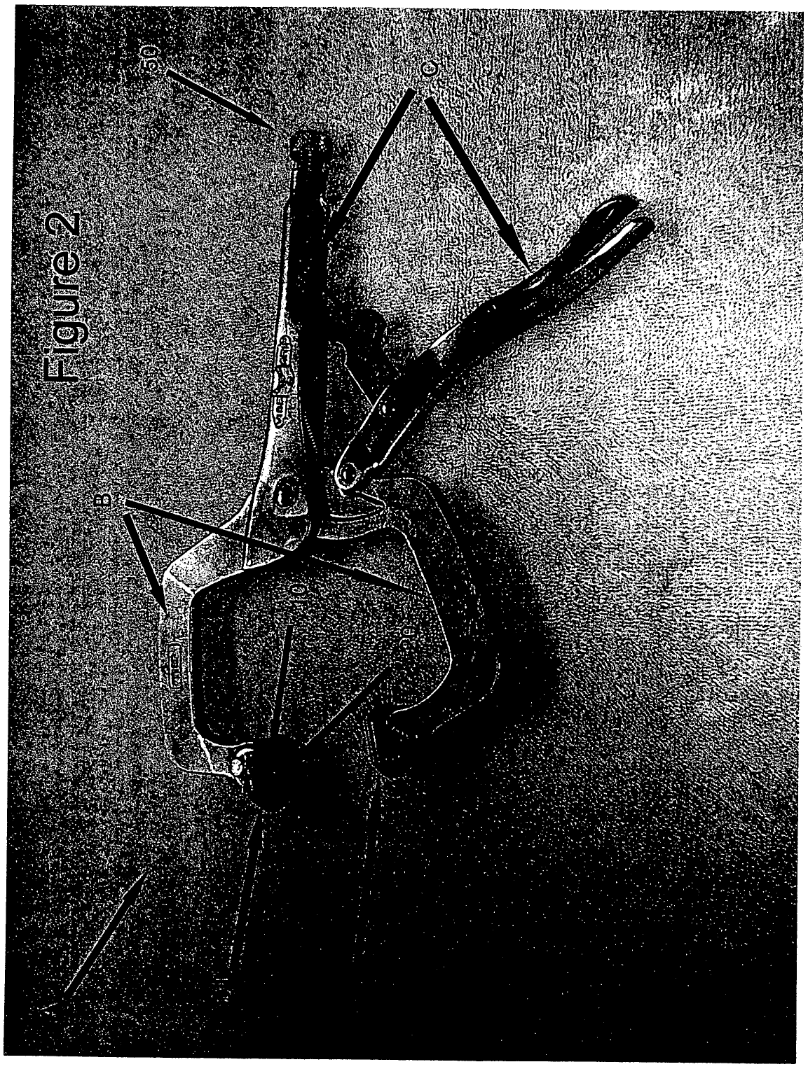

A preferred embodiment of the present invention is shown in FIG. 2. A standard number 11SP Vise Grip A (FIG. 1) is modified as follows:

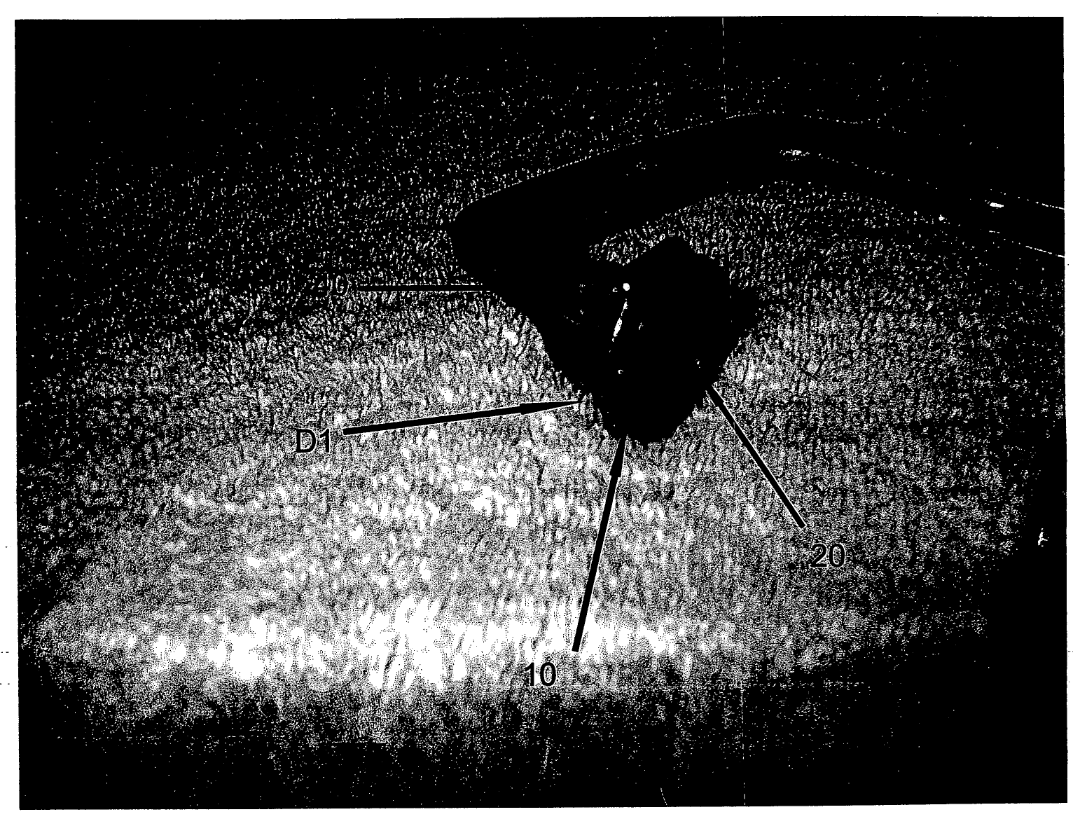

FIGS. 2 and 3 show the results after the upper foot D1 has been removed from the upper arm B by drilling out the rivets 30 (FIG. 1). The foot D1 was then clamped to a vise to avoid movement while a 1 3/8″ washer 10 was welded onto the bottom of the foot D1. A ½″ drill bit was used to drill a hole 20 approximately 1/4″ deep through the center of the washer 10 into the foot D1 (FIG. 3). The foot D1 was then reinstalled with bolts 40 the same size as the removed rivets 30 (FIG. 3).

Advantages

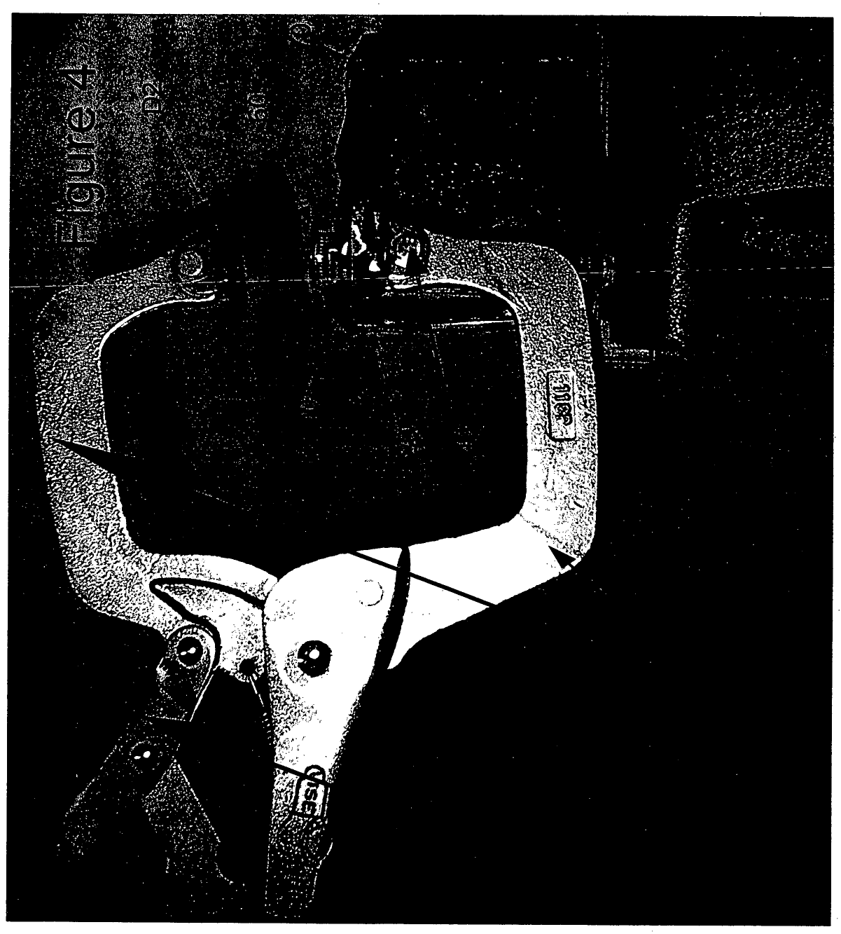

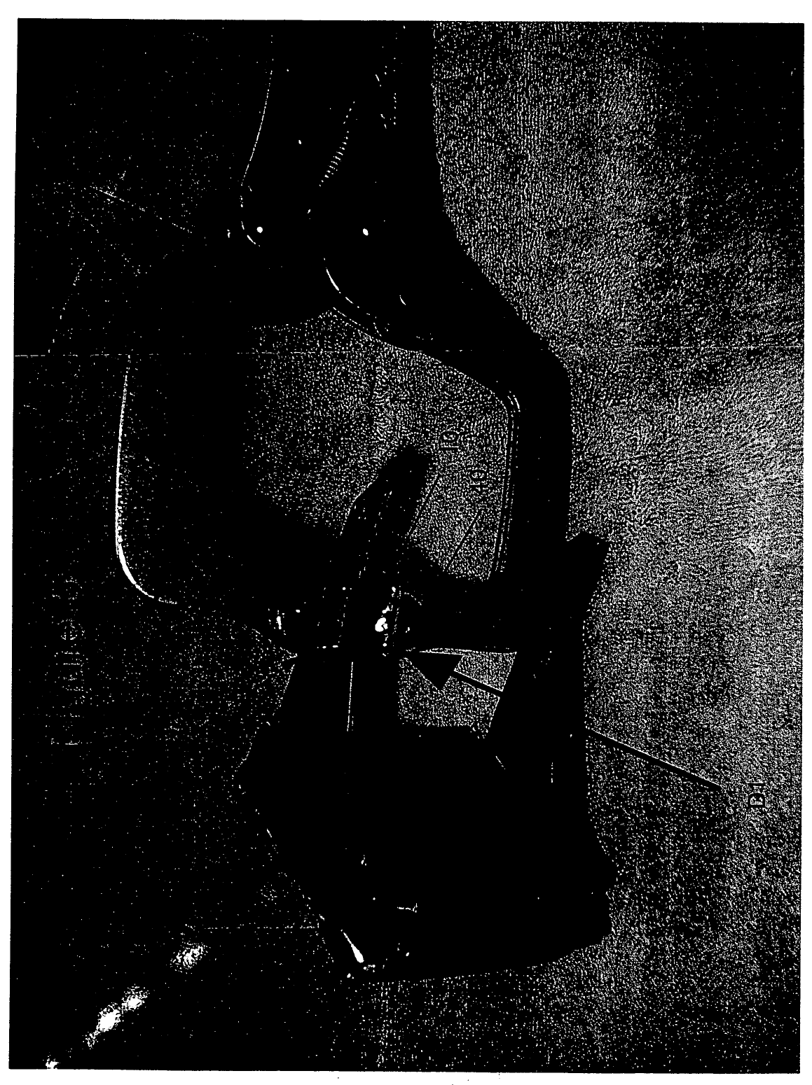

It is evident from the description above, that there are a number of advantages to the present invention:
(a) The hand tool can be used with the use of one hand.
(b) The hand tool does not require the use of any other tools.
(c) The drilled-out region inside the washer allows the bushing to be pressed straight and evenly into the hinge.
(d) All materials are easily found in any hardware store.
(e) The top door hinge bushings can be pressed by simply turning the hand tool upside down without further modification.
(f) Precious time will be saved by using this hand tool to press the bushings into place. A job that under the best circumstances takes approximately 30 minutes, will take only 2 or 3 minutes with the present invention.
   Operation—FIGS. 4 and 5

This tool is used in the same manner as the prior art, the #7 Vise Grip. One first holds the hand tool A while placing the bushing 60 in the door hinge 7 (FIG. 4), adjusting the tension screw 50 (FIG. 2) until the feet D1 and D2 meet the bushing 60. The hand grip C is squeezed to compress the arms B so that the modified foot D1 is ready to accept the bushing 60 straight and evenly into the drilled-out region 20. Adjust the tension screw 50, if necessary, until the bushing 60 is flush. FIG. 5 shows the arms B and feet D1 and D2 after the bushing 60 has been pressed into place.

Conclusion, Ramification and Scope

In conclusion, it is apparent from the photographs and description that a brass bushing can be pressed into place easily with this modified Vise Grip hand tool:
it permits the setting of bushings without the use of any other tools;
it sets both top hinge and bottom hinge bushings by simply flipping the tool upside down;
it is easily modified and adapted from any #7 Vise Grip type hand tool.

Consequently, this invention, while presented as a preferred embodiment, should not be limited to this specific design or scope of the invention. Other modifications are possible, including shaving down the arms to allow more clearance in the door hinges, or performing the present invention modifications on the bottom foot instead of the upper foot.

The appended claims and their legal equivalents should, therefore, determine the overall scope of the invention.

1. A hand tool that presses brass bushings into door hinges of some Chevrolet/GMC trucks, comprising a common C-shaped vise grip type clamp that has a modified foot.
(a.) The said foot that has been drilled-out.
(b.) The said foot that has a washer welded on.
(c.) The rivet that sets the said foot is replaced with a bolt.

2. The modified foot of claim 1 wherein the drilled-out area of the foot accommodates brass bushings used in the installation of door hinges.
